(19) United States
(12) Patent Application Publication
(10) Pub. No.: US 2011/0209086 A1
(43) Pub. Date: Aug. 25, 2011

(54) INFORMATION PROCESSING APPARATUS AND OPERATION METHOD AND OPERATION CONTROL METHOD FOR THE INFORMATION PROCESSING APPARATUS

(75) Inventors: Masanori Sambe, Shizuoka (JP); Hisashi Sato, Shizuoka (JP); Takashi Makiyama, Tokyo (JP); Yumiko Okuma, Tokyo (JP)

(73) Assignee: TOSHIBA TEC KABUSHIKI KAISHA, Tokyo (JP)

(21) Appl. No.: 13/026,461

(22) Filed: Feb. 14, 2011

(30) Foreign Application Priority Data
Feb. 19, 2010 (JP) 2010-035119
Jul. 20, 2010 (JP) 2010-163378

(51) Int. Cl. G06F 3/048

(52) U.S. Cl. 715/788

(57) ABSTRACT

According to one embodiment, an information processing apparatus includes a generating unit, a display unit, an input unit, and a processing unit. The generating unit generates a graphical user interface image including an operation area in which display components respectively associated with instructions by a user are arrayed. The display unit displays the graphical user interface image. The input unit inputs operation by the user for designating one of the display components. The processing unit executes processing corresponding to an instruction associated with the display component designated by the operation. The generating unit changes, in a period in which display of an explanation is designated by the user, the graphical user interface image to show the operation area reduced in size by reducing the sizes of the display components and an explanation image showing the explanation without superimposing the operation area and the explanation image on each other.

### CROSS-REFERENCE TO RELATED APPLICATIONS

This application is based upon and claims the benefit of priority from Japanese Patent Applications No. 2010-35119, filed on Feb. 19, 2010; and No. 2010-163378, filed on Jul. 20, 2010, the entire contents of both of which are incorporated herein by reference.

### FIELD

Embodiments described herein relate generally to an information processing apparatus and an operation method and an operation control method for the information processing apparatus.

### BACKGROUND

For example, in a large number of restaurants such as a family restaurant and a bar, various information processing apparatuses that support various jobs such as an order receiving job for menu items and a checkout job are used. These information processing apparatuses are connected to one another via a network and cooperate with one another, whereby a system that efficiently supports various jobs is often constructed.

In the information processing apparatuses, in general, a graphical user interface (GUI) is used for input of an instruction by a user. A displayed image in the graphical user interface (a graphical user interface image) includes plural display components for inputting the instruction of the user. The display components are, for example, images virtually showing buttons for designating ordered menu items.

According to the enhancement of functions of the information processing apparatuses, operation of the information processing apparatuses has become complicated. It is desired that a help image showing an operation explanation can be displayed. However, the help image is unnecessary in most cases in normal jobs. Therefore, in general, the help image is temporarily displayed according to a request from the user.

In such a case, the help image is displayed after stopping display of the graphical user interface image originally displayed or is displayed to be superimposed on the graphical user interface image (see, for example, JP-A-8-255065).

Therefore, when the help image is displayed, it is likely that display components explained as operation targets in the help image are not displayed. In this case, it is difficult for the user to grasp an explanation in the help image.

Under such circumstances, it is desired to display the explanation in the help image to allow the user to easily understand the explanation.

### BRIEF DESCRIPTION OF THE DRAWINGS

FIG. 1 is a diagram of the configuration of a customer service supporting system according to an embodiment;

FIG. 2 is a block diagram of an information terminal shown in FIG. 1;

FIG. 3 is a diagram of a file structure of a department file stored in a HDD shown in FIG. 2;

FIG. 4 is a diagram of a file structure of a PLU file stored in the HDD shown in FIG. 2;

FIG. 5 is a flowchart of processing by a CPU shown in FIG. 2;

FIG. 6 is a diagram of an example of a GUI image for order input;

FIG. 7 is a diagram of an example of a GUI image obtained by updating the GUI image shown in FIG. 6 to include an image for operation explanation; and

FIG. 8 is a diagram of a modification of the GUI image obtained by updating the GUI image shown in FIG. 6 to include the image for operation explanation.

### DETAILED DESCRIPTION

In general, according to one embodiment, an information processing apparatus includes a generating unit, a display unit, an input unit, and a processing unit. The generating unit generates a graphical user interface image including an operation area in which plural display components respectively associated with instructions by a user are arrayed. The display unit displays the graphical user interface image. The input unit inputs operation by the user for designating arbitrary one of the plural display components included in the graphical user interface image displayed by the display unit. The processing unit executes processing corresponding to an instruction associated with the display component designated by the operation input by the input unit. The generating unit changes, in a period in which display of an explanation is designated by the user, the graphical user interface image to show the operation area reduced in size by reducing the sizes of the plural display components and an explanation image showing the explanation without superimposing the operation area and the explanation image on each other.

An embodiment is explained below with reference to the accompanying drawings.

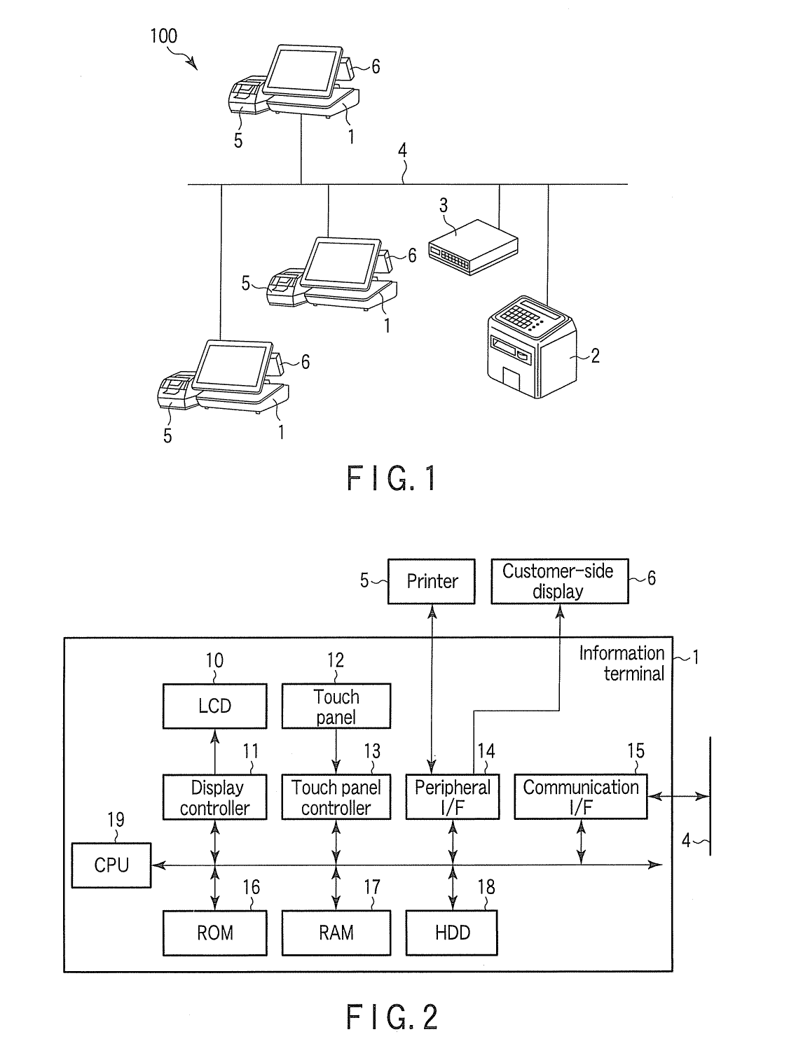

FIG. 1 is a diagram of the configuration of a customer service supporting system 100 according to this embodiment.

This customer service supporting system 100 can be used in an arbitrary facility such as an restaurant or a store that provides an eating and drinking service or a commodity sales service according to an order of a customer. However, the customer service supporting system 100 configured to be adapted to use in the restaurant is explained below.

The customer service supporting system 100 is configured by connecting three information terminals 1, a kitchen printer 2, and a station 3 to a LAN (local area network) 4. However, the information terminals 1 may include only one information terminal or may include two or four or more information terminals. The kitchen printer 2 could include two or more kitchen printers.

The information terminals 1 are set in, for example, a customer service floor and a checkout counter. The information terminals 1 perform processing for supporting various jobs such as customer attendance, order reception, table service (table setting), and checkout. In the information terminal 1 set in the customer service floor, the processing for supporting the customer attendance and the table service (the table setting) is mainly used. In the information terminal 1 set in the checkout counter, the processing for supporting checkout is further used. The information terminals 1 may be specialized for applications by performing the processing for supporting only a part of the jobs. In other words, the information terminals 1 have functions of information processing apparatuses for supporting jobs in a store.

The kitchen printer 2 is set in, for example, a kitchen and prints, for a cook, a cooking instruction slip based on order reception information transmitted from the information terminal 1.

The station 3 is set in, for example, a backyard and subjects various kinds of information transmitted from the information terminal 1 to totalizing processing to thereby support management concerning the operation of the restaurant. The station 3 may perform management processing for information used in common in the plural information terminals 1.

FIG. 2 is a block diagram of the information terminal 1.

The information terminal 1 includes a liquid crystal display (LCD) 10, a display controller 11, a touch panel 12, a touch panel controller 13, a peripheral interface (peripheral I/F) 14, a communication interface (communication I/F) 15, a read-only memory (ROM) 16, a random-access memory (RAM) 17, a hard disk drive (HDD) 18, and a central processing unit (CPU) 19. The display controller 11, the touch panel controller 13, the peripheral interface 14, the communication interface 15, the ROM 16, the RAM 17, the HDD 18, and the CPU 19 are connected to a bus line. The liquid crystal display 10 and the touch panel 12 are respectively connected to the display controller 11 and the touch panel controller 13.

The liquid crystal display 10 is driven by the display controller 11 to display an image. The display controller 11 drives, under the control by the CPU 19, the liquid crystal display 10 such that an image corresponding to image data transferred from the RAM 17 is displayed.

The touch panel 12 is laminated and arranged on a display surface of the liquid crystal display 10. When a user touches a display screen of the liquid crystal display 10, the touch panel 12 outputs a detection signal corresponding to a position touched by the user. The touch panel controller 13 calculates, on the basis of the detection signal output from the touch panel 12, coordinate information representing the touched position and sends the coordinate information to the CPU 19.

Peripherals such as a printer 5 and a customer-side display 6 are connected to the peripheral interface 14 according to necessity. The peripheral interface 14 communicates with the peripherals connected thereto. As the peripheral interface 14, for example, an interface circuit conforming to a general-purpose standard such as a universal serial bus (USB) can be used. The printer 5 is used to print an order reception slip, a receipt, various journals, and the like. The customer-side display 6 is used to display images for presenting a checkout result, advertisement information, and the like to a customer. At least one of the printer 5 and the customer-side display 6 may be incorporated in the information terminal 1.

The communication interface 15 communicates with the kitchen printer 2 and the station 3 via the LAN 4. As the communication interface 15, for example, an interface circuit conforming to a general-purpose standard such as an Ethernet (registered trademark) can be used.

The ROM 16 has stored therein, for example, computer programs that describe processing procedures of the CPU 19 and data necessary for the CPU 19 to execute various kinds of processing.

The RAM 17 stores, according to necessity, the data necessary for the CPU 19 to execute various kinds of processing. For example, image information representing an image to be displayed on the liquid crystal display 10 is stored in the RAM 17. The RAM 17 is also used as a work area by the CPU 19 to execute the various kinds of processing.

The HDD 18 has stored therein, for example, the computer programs that describe the processing procedures of the CPU 19 and the data necessary for the CPU 19 to execute the various kinds of processing. The data stored by the HDD 18 includes a department file and a price look up (PLU) file explained later. The data stored by the HDD 18 also includes data representing display components serving as materials for generating various images. The display components include button components displayed on the graphical user interface image.

The CPU 19 executes, according to the computer programs stored in the ROM 16 and the HDD 18, the various kinds of processing for supporting the various jobs. The various kinds of processing for supporting the jobs are, for example, processing for receiving orders of menu items.

The information terminal 1 may be sold or transferred in a state in which the computer programs are stored in the ROM 16 and the HDD 18. Alternatively, the computer programs stored in a storage medium or sold or transferred by communication via a communication line may be arbitrarily installed in the information terminal 1. As the storage medium, all kinds of storage media such as a magnetic disk, a magneto-optical disk, an optical disk, and a semiconductor memory can be used.

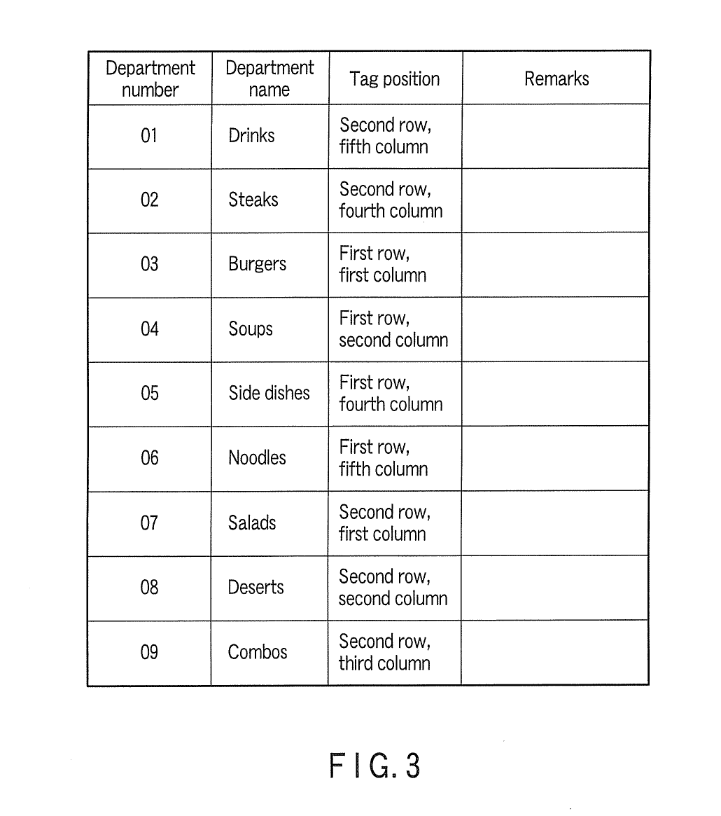

FIG. 3 is a diagram of a file structure of the department file.

The department file includes a set of plural data records respectively including information fields of a department number, a department name, a tag position, and remarks. In the data records, pieces of information concerning individual departments are respectively described. Specifically, in the information field of the department number, numbers respectively allocated to plural departments set to classify menu items are described. In the information field of the department name, names for respectively identifying the departments are described. In the information field of the tag position, the positions of the button components in the graphical user interface image (hereinafter referred to as GUI image) for order input explained later are described. In the information field of the remarks, other kinds of reference information are described according to necessity. In FIG. 3, the reference information is not described in any of the data records.

In an example shown in FIG. 3, the department file describes that nine departments “Drinks”, “Steaks”, “Burgers”, “Soups”, “Side dishes”, “Noodles”, “Salads”, “Deserts”, and “Combos” are set and department numbers “01” to “09” are respectively allocated to the departments. The department file describes that, for example, the position of the button component corresponding to the department “Drinks” is “second row, fifth column”.

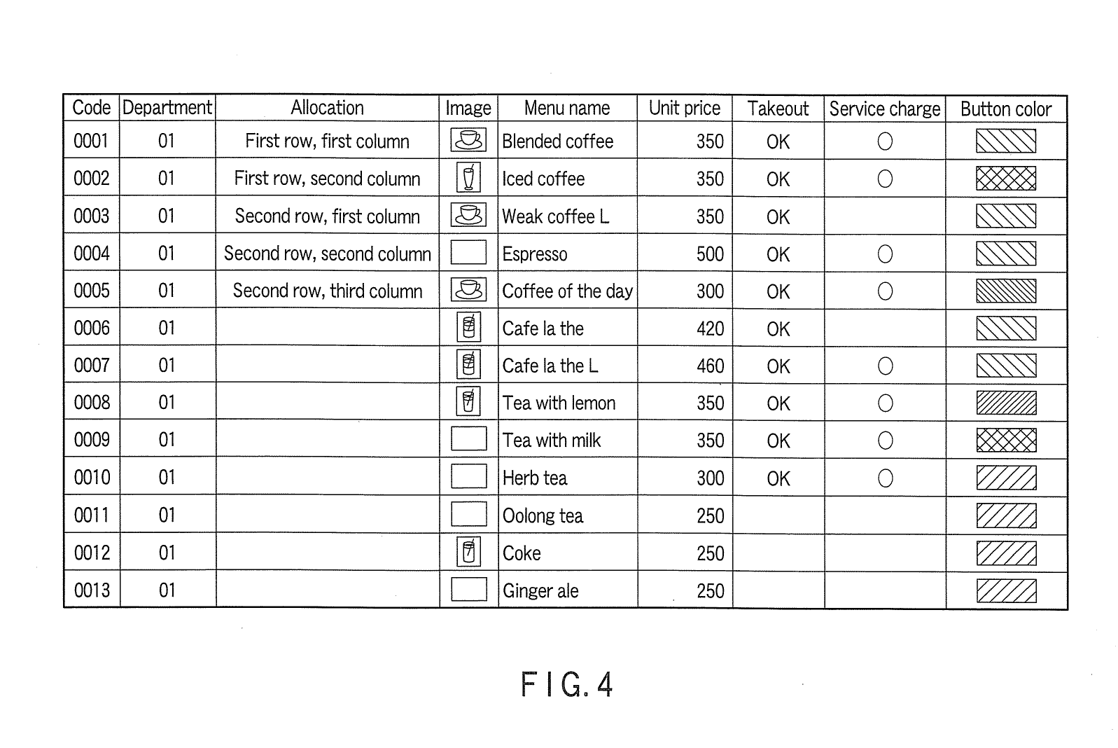

FIG. 4 is a diagram of a file structure of the PLU file.

The PLU file includes a set of plural data records respectively including information fields of a code, a department, allocation, an image, a menu name, a unit price, takeout, a service charge, and a button color. Information concerning individual menu items is described in the data records. In the information field of the code, codes allocated to the menu items are described. In the information field of the department, department numbers of departments to which the menu items belong are described. In the information field of the allocation, the positions of the button components on the GUI image for order input are described. In the field of the image, images displayed to be superimposed on the button components are described. In the information field of the menu name, names of the menu items are described. In the information field of the unit price, unit prices of the menu items are described. In the information field of the takeout, possibility of takeout of the menu items is described. In the information field of the service charge, it is described whether the menu items are targets of service charge collection. In the information field of the button color, colors of the button components are described.

The department file and the PLU file are created, for example, as a part of installation work for the customer service supporting system 100 on the basis of the actual conditions of business in an restaurants in which the customer service supporting system 100 is used. The department file and the PLU file are written in the HDD 18. The department file and the PLU file may be stored by only a storage medium incorporated in or connected to the station 3 or may be stored in both such a storage medium and the HDD 18.

The operation of the customer service supporting system 100 is explained below.

When order information concerning an order of a customer is input to the information terminal 1 by a store clerk, the input order information is transmitted to the station 3 via the LAN 4. The station 3 receives the order information and manages, for checkout processing, totalizing processing, and the like, the received order information. The station 3 transmits the order information to the kitchen printer 2 via the LAN 4. The kitchen printer 2 prints a cooking instruction slip having content corresponding to the received order information.

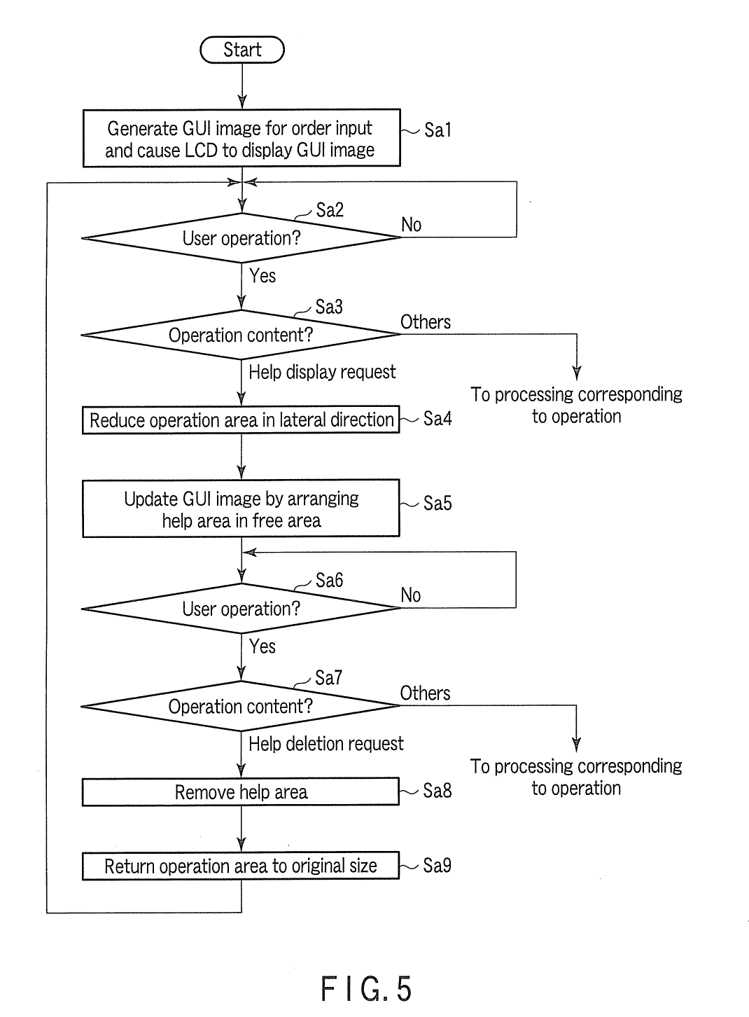

The information terminal 1 used for the input of the order information is set in an order input mode by, for example, the store clerk. When the information terminal 1 is set in the order input mode, the CPU 19 executes processing shown in FIG. 5. In FIG. 5, only a characteristic part of processing according to this embodiment is shown.

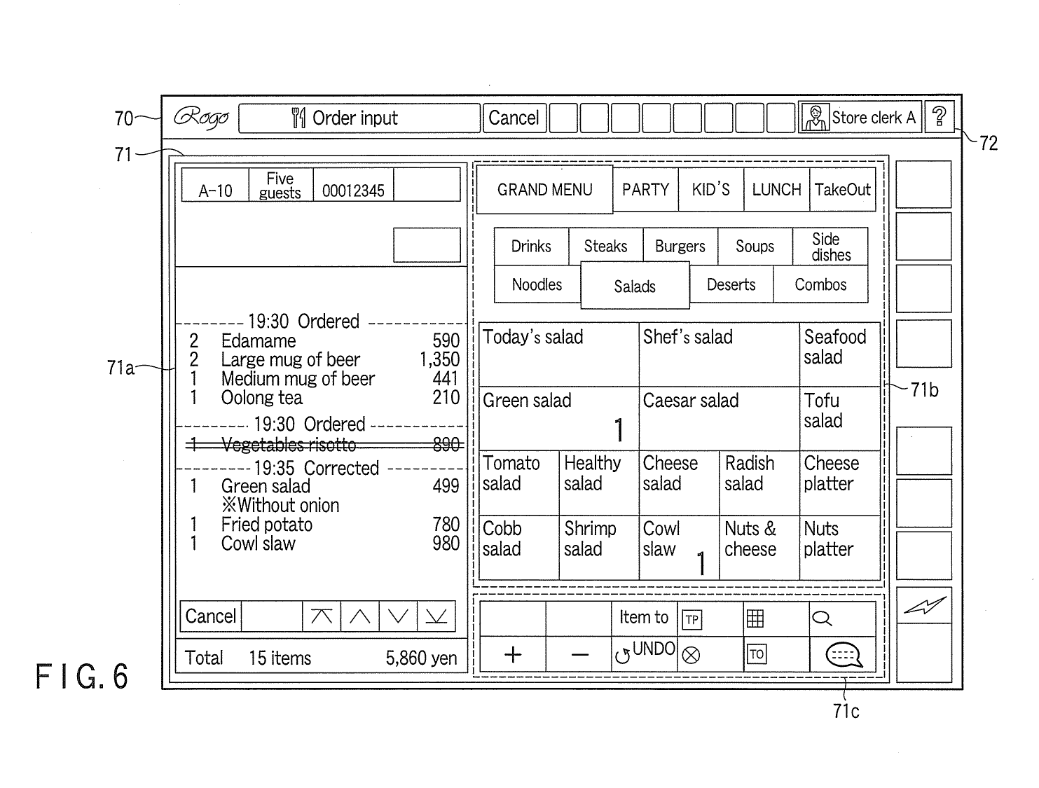

In Act Sa1, the CPU 19 generates a GUI image for order input and causes the LCD 10 to display the GUI image. Specifically, the CPU 19 generates image data indicating a GUI image 70 having a layout shown in FIG. 6 and writes the image data in the RAM 17.

The GUI image 70 includes an operation area 71 for order input. The operation area 71 includes areas 71a, 71b, and 71c. A result of the order input is shown in the area 71a. Plural button components are shown in the area 71b. Plural button components for designating additional functions concerning order input operation are shown in the area 71c.

The button components shown in the area 71b include plural button components respectively associated with departments and plural button components respectively associated with menu items. The plural button components respectively associated with the menu items are button components for inputting user operation for instructing to perform processing for order reception of the menu items associated with the button components. A first area showing the plural button components respectively associated with the departments and a second area showing the plural button components respectively associated with the menu items are individually defined in advance. The CPU 19 determines the positions of the button components in the first and second areas on the basis of each of the pieces of information described in the department file and the PLU file. The CPU 19 reads out, from the HDD 18, the information concerning the button components that should be shown in the areas 71b and 71c and expands the information in the RAM 17 according to the positions.

The GUI image 70 also shows plural button components on the outside of the operation area 71. A button component 72 as one of the button components is associated with a request for display of an operation explanation (help display).

The area 71a in FIG. 6 shows a state after order input is performed. This is for the purpose of making it easy to grasp a function of the area 71a. The GUI image generated by the CPU 19 in Act Sa1 does not include information concerning a specific result of order input yet.

When finishing generating the image data indicating the GUI image 70, the CPU 19 transfers the image data to the display controller 11 and instructs the display controller 11 to display the image data. According to the instruction, the display controller 11 drives the LCD 10 to display the GUI Image 70 corresponding to the transferred image data.

In the state in which the GUI image 70 is displayed by the LCD 10, in Act Sa2, the CPU 19 waits for GUI operation to be performed by the user. In this embodiment, the user performs the GUI operation by touching a display screen of the LCD 10 with a finger or the like. If a detection signal is given from the touch panel controller 13, the CPU 19 determines that the GUI operation by the user is performed and proceeds from Act Sa2 to Act Sa3.

In Act Sa3, the CPU 19 determines content of the GUI operation. Specifically, the CPU 19 determines a touched position on the basis of the detection signal and determines that execution of processing for realizing a function allocated to the touched position is instructed by the user. For example, if the user touches the display screen to touch a button component associated with a menu item, the CPU 19 determines that the user performs user operation for order input of the menu item associated with the button component.

If execution of processing for realizing a function other than the help display is instructed by the user, the CPU 19 shifts to not-shown processing corresponding to the instruction and executes the processing. For example, if the user touches a button component associated with a department to thereby instruct switching of the department, the CPU 19 updates the area 71b to show a button component of a menu item belonging to the department associated with the touched button component. If the user touches a button component associated with a menu item to thereby instruct order input, the CPU 19 transmits order information concerning the menu item associated with the touched button component to the station 3 and updates the display content in the area 71a to show a result of the order input. Except when a request satisfying an end condition for the processing shown in FIG. 5 such as the start of processing for supporting another job or the stop of the processing is made, the CPU 19 returns to the waiting state in Act Sa2 after the completion of the processing corresponding to the operation.

For example, if the user touches the button component 72 to request the help display, the CPU 19 proceeds from Act Sa3 to Act Sa4.

In Act Sa4, the CPU 19 reduces, in a lateral direction and at a fixed ratio, an image in the operation area 71 in the GUI image 70 displayed on the LCD 10 at that point.

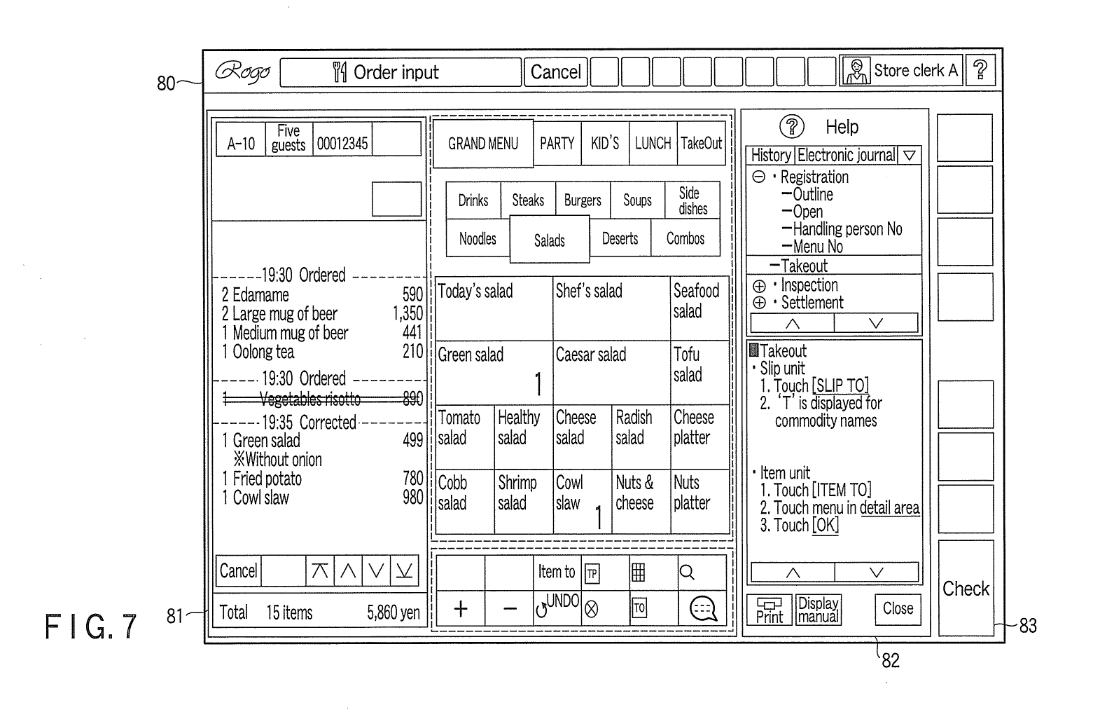

In Act Sa5, the CPU 19 updates an image to be displayed on the LCD 10 to a GUI image 80 having a layout shown in FIG. 7. Specifically, the CPU 19 arranges an operation area 81, which is obtained by reducing the operation area 71, to be set close to the left end of the operation area 71 in the GUI image 70. The CPU 19 uses a free space, which is formed because the operation area 81 is smaller than the operation area 71, as a help area and arranges a help area 82 in this help area to thereby generate the GUI image 80. Data representing the help area 82 is stored in the ROM 16 or the HDD 18 in advance. The CPU 19 expands an image based on the data in the RAM 17. As the data representing the help area 82, data created by using a well-known page description language such as hypertext markup language (HTML) can be used. Besides the operation area 81 and the help area 82, plural button components are shown on the GUI image 80. Input of a deletion request for display of the operation explanation (the help display) is associated with a button component 83 as one of the button components.

In a state in which the GUI image 80 is displayed by the LCD 10, in Act Sa6, the CPU 19 waits for GUI operation to be performed by the user. If the GUI operation by the user is performed, the CPU 19 proceeds from Act Sa6 to Act Sa7.

In Act Sa7, the CPU 19 determines content of the GUI operation.

If a function other than the deletion of the help display is designated, the CPU 19 shifts to not-shown processing corresponding to the designation and executes the processing. For example, if a hyperlink is set in an image for operation explanation and the user touches the display screen to touch a place where the hyperlink is set, the CPU 19 updates the image for operation explanation to show information concerning a link destination. Except when a request satisfying the end condition for the processing shown in FIG. 5 such as the start of processing for supporting another job or the stop of the processing is made, the CPU 19 returns to the waiting state in Act Sa6 after the completion of the processing corresponding to the operation.

If the user touches, for example, the button component 83 to request deletion of the help display in the waiting state in Act Sa6, the CPU 19 proceeds from Act Sa7 to Act Sa8.

In Act Sa8, the CPU 19 removes the help area. Then, in Act Sa9, the CPU 19 returns the operation area to the original operation area and returns the display image on the LCD 10 to the GUI image having the original layout such as the GUI image 70.

Thereafter, the CPU 19 returns to the waiting state in ACT Sa2.

As explained above, if the request for the help display is made in a state in which the GUI image 70 for order input is displayed on the LCD 10, the information terminal 1 reduces the operation area 71 in the GUI image 70 and changes the display on the LCD 10 to the GUI image 80 on which the explanation image is shown in the help area 82, which is the free area generated by the reduction of the operation area 71. In other words, in the GUI image 80, images showing all pieces of information shown in the operation area 71 when the request for the help display is made and the image for operation explanation are shown side by side. Therefore, the user can check, while directly visually checking each of the button components displayed in the operation area 71, an explanation concerning the button component using the explanation image.

Various modifications of this embodiment are possible as explained below.

An apparatus that supports an order reception job different from that in the above embodiment such as reception of an order of commodity purchase in a store, can be realized in the same manner as in the embodiment. A display of a GUI image in processing for supporting various jobs such as checkout and sales totalizing, can be realized in the same manner as in the above embodiment.

The GUI operation may be performed using other pointing devices such as a mouse.

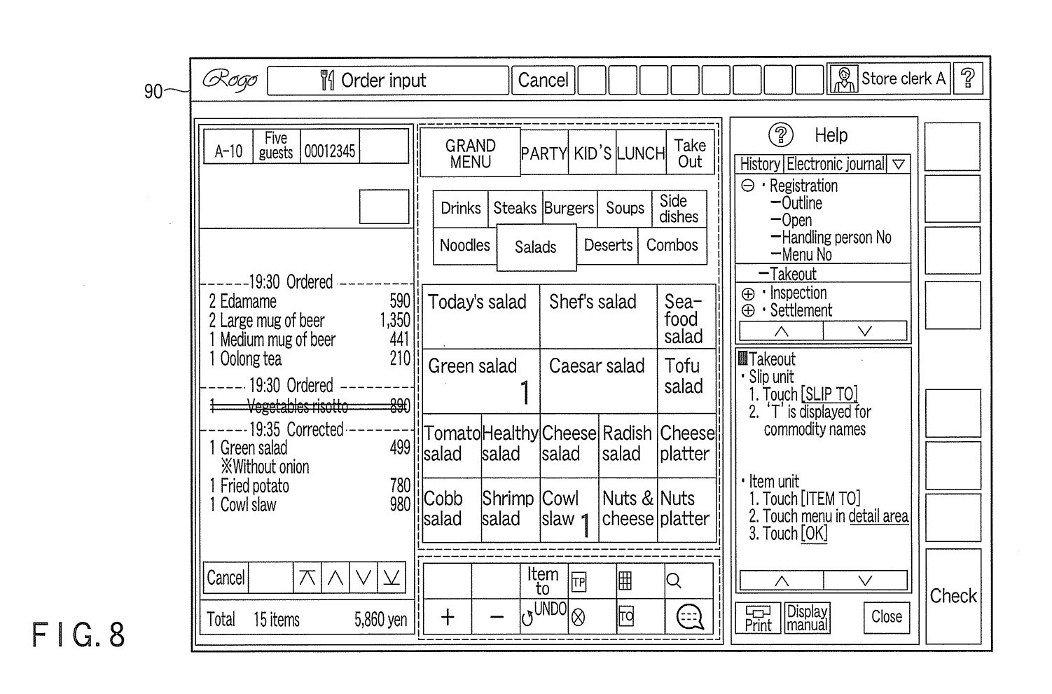

When an image shown in the operation area 71 is reduced, it is also possible to reduce only the button components and not to reduce the size of characters shown on the button components. Then, the user can easily discriminate the functions of the button components. In this case, it is desirable to, for example, add line break anew or, if the characters are already in a line break state, change line break positions to show all the characters on the reduced button components. A GUI image 90 generated by updating the GUI image 70 shown in FIG. 6 in this way is shown in FIG. 8. For example, whereas a character string “Today's salad” is arrayed in one row in the GUI image 70, the character string is updated to be arrayed in two rows in the GUI image 90.

When the image shown in the operation area 71 is reduced, if the characters shown on the button components can be shown on the reduced button components without the size of thereof being changed, the characters may be shown without the size thereof being changed. If the characters shown on the button components cannot be shown on the reduced button components without the size of thereof being changed, the size of the characters may be changed to be small.

A job to be supported does not need to be a job of the user of the information terminal 1. Specifically, for example, a self-register apparatus that executes, according to operation by a customer, processing for supporting a job for inputting information concerning purchased commodities, can be realized in the same manner as in the above embodiment.

A procedure for changing the GUI image may be arbitrary. For example, after the help area is set and the image for operation explanation is displayed, a reduced image is displayed in an area on the outside of the help area to generate the GUI image.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a generating unit configured to generate a graphical user interface image including an operation area in which plural display components respectively associated with instructions by a user are arrayed;
a display unit configured to display the graphical user interface image;
an input unit configured to input operation by the user for designating arbitrary one of the plural display components included in the graphical user interface image displayed by the display unit; and
a processing unit configured to execute processing corresponding to an instruction associated with the display component designated by the operation input by the input unit, wherein
the generating unit changes, in a period in which display of an explanation is designated by the user, the graphical user interface image to show the operation area reduced in size by reducing sizes of the plural display components and an explanation image showing the explanation without superimposing the operation area and the explanation image on each other.

2. The apparatus of claim 1, wherein the generating unit reduces characters included in the display components after being reduced in size compared with the characters included in the display components before being reduced in size.

3. The apparatus of claim 1, wherein the generating unit changes arrangement of characters included in the display components without changing size of the characters before and after the display components are reduced in size.

4. The apparatus of claim 1, wherein the generating unit changes, if all characters included in the display components can be arranged in the display components reduced in size without size of the characters being changed, arrangement of the characters without changing size of the characters before and after the display components are reduced in size and reduces, if all the characters included in the display components cannot be arranged in the display components reduced in size without the size of the characters being changed, the characters included in the display components after being reduced in size compared with the characters included in the display components before being reduced in size.

5. The apparatus of claim 1, wherein the generating unit generates the graphical user interface image to include a result image showing a result of the processing by the processing unit and also reduces the result image in the period in which the display of the explanation is designated by the user.

6. The apparatus of claim 5, wherein the generating unit changes, in the period in which the display of the explanation is designated by the user, the graphical user interface image to show the explanation image without superimposing the explanation image on both of the operation area and the result image.

7. The apparatus of claim 1, wherein the generating unit generates the explanation image as an image showing an explanation concerning operation on the graphical user interface image.

8. The apparatus of claim 1, wherein the processing unit performs, as the processing, processing for supporting a job concerning customer service in a store.

9. An operation method for an information processing apparatus including: a display unit configured to display a graphical user interface image;
and an input unit configured to input operation by a user for designating arbitrary one of plural display components included in the graphical user interface image displayed by the display unit,
the method comprising:
generating the graphical user interface image to include an operation area in which the plural display components respectively associated with instructions by the user are arrayed;
executing processing corresponding to an instruction associated with the display component designated by the operation input by the input unit; and
changing, in a period in which display of an explanation concerning the processing is designated by the user, the graphical user interface image to show the operation area reduced in size by reducing sizes of the plural display components and an explanation image showing the explanation without superimposing the operation area and the explanation image on each other.

10. An operation control method for an information processing apparatus including: a display unit configured to display a graphical user interface image; an input unit configured to input operation by a user for designating arbitrary one of plural display components included in the graphical user interface image displayed by the display unit; and a computer,
the method comprising:
the computer generating the graphical user interface image to include an operation area in which the plural display components respectively associated with instructions by the user are arrayed;
the computer executing processing corresponding to an instruction associated with the display component designated by the operation input by the input unit; and
the computer changing, in a period in which display of an explanation concerning the processing is designated by the user, the graphical user interface image to show the operation area reduced in size by reducing sizes of the plural display components and an explanation image showing the explanation without superimposing the operation area and the explanation image on each other.
